(19) United States
(12) Patent Application Publication
(10) Pub. No.: US 2015/0110937 A1
(43) Pub. Date: Apr. 23, 2015

(54) RICE COOKING METHOD

(71) Applicants: Osaka Prefecture University Public Corporation, Sakai-shi, Osaka (JP); ACESYSTEM CO., LTD., Izumi-shi, Osaka (JP)

(72) Inventors: Yoshihiro Sako, Osaka (JP); Hatsuho Takemitsu, Sakai-shi (JP); Shinichi Kitamura, Sakai-shi (JP)

(21) Appl. No.: 14/398,071

(22) PCT Filed: Feb. 6, 2013
(86) PCT No.: PCT/JP2013/052740

§ 371 Date: Oct. 30, 2014

(30) Foreign Application Priority Data
May 1, 2012 (JP) 2012-104977

(51) Int. Cl. A23L 1/10; A23L 1/01

(52) U.S. Cl. CPC A23L 1/1033; A23L 1/0121; A23V 2002/00
USPC 426/508

(57) ABSTRACT

[Problem] To provide cooked rice in which aging can be suppressed without using low-amylose rice and which shows little deterioration in taste even after storing at ordinary or low temperatures.

[Solution] In a rice cooking device provided with a conveying means such as a conveyor for conveying rice having been soaked in water, a steamer for steaming the rice on the conveyor with hot steam, and a water sprinkler for supplying warm water to the rice on the conveyor in the steamer, warm water is poured in an amount exceeding the amount required for cooking the rice in the aforesaid step for steaming in the steamer so as to wash away amylose eluted from the rice.

### TECHNICAL FIELD

The present invention relates to a rice cooking method.

### BACKGROUND ART

Rice cooking is generally performed by: a water absorbing process in which rice is made to absorb water; a start-up heating process in which water is added to the rice having absorbed water and a boiling state is obtained; a boiling maintaining process in which rice is continuously cooked while maintaining the boiling state; and a steaming process in which the cooked rice is steamed after being heated.

It is a well-known phenomenon that a so-called “oneba” which is a white sticky liquid blows out during rice cooking. The oneba contains umami components such as amino acids, starch and the like originally contained in rice, and coating on a surface of the rice with the oneba again in the steaming process is said to give luster to the rice and to make the rice tasty. In view of this, Patent Literature 1, for example, discloses a rice cooking device which temporarily stores the oneba boiling over a pot in the rice cooking process and returns the oneba stored in the steaming process into the pot.

On the other hand, Patent Literatures 2 to 5 disclose rice cooking devices which can continuously cook rice. The rice cooking devices disclosed in Patent Literature 2 and Patent Literature 3 are provided with a primary steaming device for applying primary steaming to rice grains while conveying them by a conveyer, a secondary steaming device for performing secondary steaming while conveying by the conveyer after the primary steaming for gelatinization of the rice grains, and a water sprinkling means for sprinkling warm water to the rice grains conveyed by the conveyer when the primary and secondary steaming is performed in order to cook rice while steam is supplied. In these devices, the rice grains are heated by saturated steam at 110 to 115° C. in the primary steaming device or the secondary steaming device, and the warm water at approximately 80° C. is sprinkled for adding water.

The rice cooking devices disclosed in Patent Literature 4 and Patent Literature 5 are provided with: a first conveyer means provided in a first steam chamber; a second conveyer means provided in a second steam chamber provided immediately below the first steam chamber; a third conveyer means provided in a third steam chamber provided immediately further below the second steam chamber; a primary steaming means for performing primary steaming in the first steam chamber; a secondary steaming means for performing secondary steaming in the second steam chamber; and a water sprinkling means for sprinkling water during the primary steaming and the secondary steaming, respectively. In these rice cooking devices, the rice grains are heated by overheat steam at approximately 140° C. and approximately 0.36 MPa in the first steam chamber and by overheat steam at approximately 150° C. and approximately 0.48 MPa in the second steam chamber and warm water at approximately 60 to 90° C. is sprinkled for adding water. Moreover, tertiary steaming might be performed in the third steam chamber in some cases.

In the continuous rice cooking method as above, high-temperature steam at 100° C. or above is supplied to the rice grains and thus, the rice grains are immediately heated close to 100° C. or above, but since the rice grains are heated to the high temperature instantaneously, a water content of the rice grains is rapidly reduced. Thus, the warm water is sprinkled so as to give moisture to the rice grains in rice cooking. In this type of continuous rice cooking, the oneba is not generated, and most of the umami components contained in the oneba is held in the rice grains.

However, in so-called batch type rice cooking using a pot such as a rice cooker, the oneba adheres to the surface of rice (also referred to as cooked rice) and thus, if the rice is stored at a normal temperature or at a low temperature as in a refrigerator, so-called aging occurs, and the rice becomes dry and tasteless, which is a problem.

Moreover, the oneba is not generated in continuous rice cooking, but if the rice is stored at a normal temperature or at a low temperature, aging occurs and the rice becomes tasteless in some cases similarly to the rice cooked in the batch type, which is a problem.

As a method for suppressing such aging so as to provide cooked rice food which can be distributed at a low temperature, Patent Literature 6 proposes a method of cooking non-glutinous rice with an amylose content at 15% or less or particularly at 10% or less.

However, the method disclosed in Patent Literature 6 is a rice cooking method using a type of rice with less amylose content and can be applied only to a specific type of rice.

### CITATION LIST

### Patent Literature

Patent Literature 1: Japanese Patent Laid-Open No. 2009-000187

Patent Literature 2: Japanese Patent Laid-Open No. H9-107896

Patent Literature 3: Japanese Patent Laid-Open No. H9-294678

Patent Literature 4: Japanese Patent Laid-Open No. 2001-169915

Patent Literature 5: Japanese Utility Model Registration Laid-Open No. 3142166

Patent Literature 6: Japanese Patent Laid-Open No. H9-322725

### SUMMARY OF INVENTION

### Technical Problem

The inventors of the invention of the present application have examined rice cooking conditions through trials and errors by using a continuous rice cooking device having a steaming process by a high-temperature steam and found that rice with less deterioration in a taste even after storage at a normal temperature or a low temperature was cooked and completed the invention of the present application.

That is, the present invention has an object to provide cooked rice having aging suppressed and less deterioration in the taste even after normal-temperature storage or low-temperature storage without using low amylose rice containing less amylose.

### Solution to Problem

The present invention is a rice cooking method characterized by comprising a process of washing away amylose eluted from rice during rice cooking.

### Advantageous Effect of Invention

According to the present invention, cooked rice with aging suppressed and a good taste maintained even after normal-temperature storage or low-temperature storage is provided.

### BRIEF DESCRIPTION OF THE DRAWINGS

FIG. 1 is an outline view of a rice cooking device used in a rice cooking method which is an embodiment of the present invention.

FIG. 2 is a graph illustrating a relationship between a water added state and an eluted amylose amount in the rice cooking device in FIG. 1.

FIG. 3 are graphs illustrating a temporal change of a surface color of cooked rice (polished rice) cooked in the rice cooking device in FIG. 1 and a surface color of cooked rice (polished rice) cooked in a rice cooker sold in the market.

FIG. 4 are graphs illustrating a temporal change of elasto-viscosity of the cooked rice (polished rice) cooked in the rice cooking device in FIG. 1 and elasto-viscosity of cooked rice (polished rice) cooked in a rice cooker sold in the market. FIG. 4(a) illustrates a temporal change of hardness, and FIG. 4(b) illustrates a temporal change of viscosity.

FIG. 5 are views comparing a result of a sensory test of the cooked rice (polished rice) cooked in the rice cooking device in FIG. 1 and a result of a sensory test of cooked rice (polished rice) cooked in a rice cooker sold in the market.

FIG. 6 is a graph illustrating a relationship between a water added state and an eluted amylose amount in the rice cooking device in FIG. 1.

FIG. 7 is a graph illustrating a temporal change of hardness of the cooked rice (polished rice) cooked in the rice cooking device in FIG. 1.

FIG. 8 is a graph illustrating a temporal change of stickiness of the cooked rice (polished rice) cooked in the rice cooking device in FIG. 1.

FIG. 9 is a graph illustrating a temporal change of hardness of sushi rice obtained by cooking rice in the rice cooking device in FIG. 1.

FIG. 10 is a graph illustrating a temporal change of stickiness of sushi rice obtained by cooking rice in the rice cooking device in FIG. 1.

### DESCRIPTION OF EMBODIMENTS

A rice cooking method of the present invention includes a process of adding water and heating to rice having absorbed water, and is provided with a process of washing away amylose eluted from rice in the process of adding water and heating.

The rice cooking method of the present invention includes a steaming process by a high-temperature steam and can be performed easily by a continuous rice cooking method in which warm water is added in the steaming process. That is, in the continuous rice cooking method involving the steaming process, the present invention can be performed by pouring warm water in an amount larger than a water adding amount required for rice cooking and by washing away amylose eluted from the rice in the steaming process.

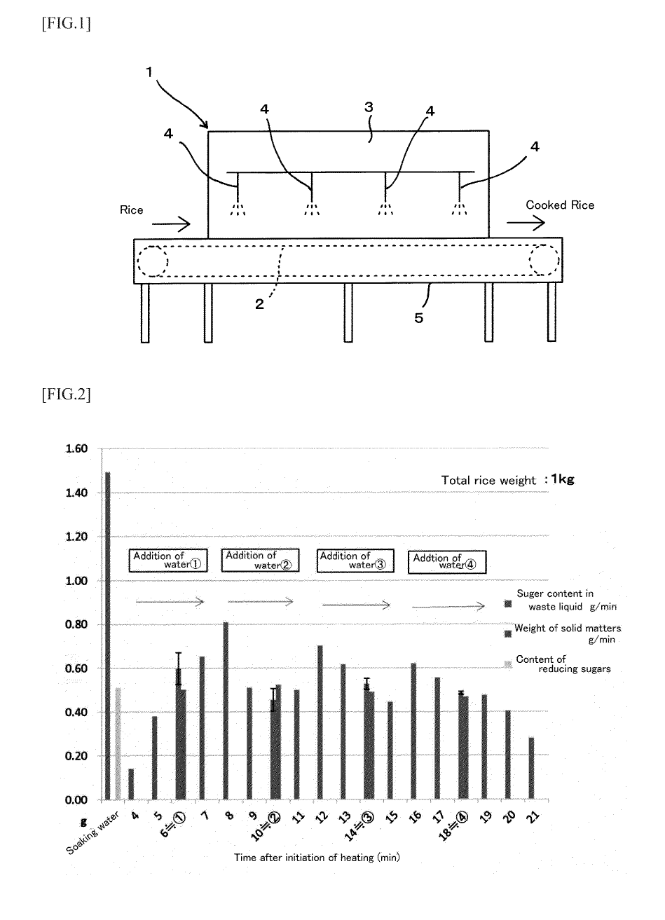

The continuous rice cooking method can be performed by a rice cooking device comprising: a conveying means such as a conveyer for conveying rice having absorbed water; a steaming device for steaming the rice by a high-temperature steam on the conveyer which is the conveying means; and a water sprinkler for supplying warm water to the rice on the conveyer in the steaming device. The steaming device is provided with a steam chamber to which the high-temperature steam is supplied and is a device for steaming the rice moving on the conveyer in the steam chamber. Moreover, the steaming device has the water sprinkler for pouring (or sprinkling) warm water to be added to the rice moving on the conveyer. The rice cooking device may have any structure as long as it is as above, and a rice cooking device performing the steaming process on a single line of conveyer (a rice cooking device illustrated in FIG. 1, for example) or a rice cooking device performing the steaming process on a plurality of lines of conveyers (the rice cooking devices disclosed in Patent Literatures 2 to 5, for example) can be used.

In the rice cooking method according to the present invention, warm water in an amount larger than a water adding amount usually required for rice cooking is poured in the steaming process in order to wash away amylose eluted to the surface of the rice in the steaming process. The water adding amount usually required for rice cooking is an amount increased by 10 to 20% from the amount of rice in general in the case of the batch method cooking using a pot, that is, an amount of 110 to 120% of the rice. The water adding amount is larger in the case of the continuous type, and 130 to 160% of the rice amount is a reference and is set as appropriate depending on a water absorbing amount before rice cooking, water absorbing time or a temperature in water absorption, softness of rice obtained by the rice cooking and the like. It is only necessary that the amount of warm water is an amount that can wash away a part of amylose eluted to the surface of the rice in the steaming process, and there is no need to wash away the full amount of the eluted amylose. That is, it is necessary that warm water poured from the water sprinkler falls below the conveyer, and the water adding amount to a degree that supplied steam is cooked and dropped as in the usual rice cooking is not sufficient. The amylose amount remaining on the surface of the rice grains becomes large, and there is a concern that progress of aging cannot be delayed. Specifically, the amount is 1.1 times of the required water adding amount or can be 1.5 times, 2 times, 2.5 times, and 3 times, but it is preferably 1.5 times or more preferably 2 times or more. Since the water pouring amount is determined by an outflow speed from the water sprinkler, the water pouring amount is actually adjusted by increasing the outflow speed. The usually required water adding amount differs depending on a size of a facility (throughput) but an example thereof is approximately 0.65 to 0.8 L/min in the case of the rice cooking device with the throughput per minute of 0.5 kg of rice. Therefore, in the present invention, a water amount larger than that is needed, and the device requires the water adding amount of at least approximately 0.72 L/min or more, preferably the water adding amount of 0.8 L/min or more or further preferably the water adding amount of 1.0 L/min or more.

The temperature of the warm water is approximately 60 to 90° C. and is set as appropriate by those skilled in the art. Moreover, the temperature of the high-temperature steam used in the steaming process is also approximately 90 to 150° C. and is set as appropriate by those skilled in the art. The rice cooking conditions other than the water pouring amount of the warm water such as temperature of the warm water, temperature and pressure of the high-temperature steam, a rice washing condition, a soaking condition before rice cooking and the like are substantially the same as conventional rice cooking conditions, and the rice cooking method according to the present invention is characterized in that the water pouring amount is set larger than that in the conventional rice cooking condition and amylose eluted to the surface of the rice is washed away in the middle of the steaming process.

Pouring an excessive amount of water required for washing away amylose may be performed at any timing as long as it is during the steaming process. For example, water may be poured in an equal amount in the steaming process or the water pouring amount may be made larger at certain timing in the steaming process. Specifically, the water pouring amount is made larger for some time immediately after start of the steaming process, that is, at an initial stage of the steaming process and then, the water pouring amount is reduced in the subsequent stage of the process, for example. This is based on the fact that a large amount of amylose was detected at the initial stage of the steaming process, though details of timing and mechanism of eluting of amylose in the continuous rice cooking is not known (see examples). It is assumed that the temperature of rice rises immediately after the start of the steaming process, and amylose is eluted at this time. That is, by setting the large water pouring amount at the initial stage of the steaming process, it is assumed that amylose eluted to the surface of the rice is effectively washed away and aging is suppressed while the rice remains tasty. The initial stage is a period for 10 minutes after start of rice cooking and it can be a period for 8 minutes, for example. However, as long as amylose can be washed away by an excessive amount of water adding, the warm water may be poured uniformly over the steaming process as described above, and it is needless to say that the water pouring amount may be increased at an ending stage of the steaming process. However, the timing of pouring the excessive amount of water can be set as appropriate depending on an eluting situation of amylose (eluting timing or eluted amount, for example) or cooked state of the rice.

The rice cooking method according to the present invention is characterized in that amylose eluted in the steaming process is washed away by warm water and was invented from the fact that amylose in starch contained in rice was detected in a washed-away liquid (waste liquid) and little amylopectin was detected. Though the excessive amount of warm water is poured in this rice cooking method, the amylose contained in rice is not eluted in the full amount and it is needless to say that this rice cooking method is not a method of eluting all the amylose contained in the rice and of washing it away or a method of washing away all the eluted amylose. Moreover, this rice cooking method is not a method of selectively washing away only amylose without washing away amylopectin eluted from the rice but includes a case in which amylopectin is washed away.

The rice cooking method of the present invention is not a method applied only to the continuous rice cooking method in which water is added during the above-described steaming process but can be also applied to the batch type rice cooking method using a pot. In this description, the batch type rice cooking method means a rice cooking method using a pot, i.e., means a rice cooking method using one pot such as rice cooking using a rice cooker or a method of continuously cooking rice using a plurality of pots arranged in a stack. As the batch type rice cooking method as above, for example, a method in which, in a start-up heating process in which water is added to the rice having absorbed water and a boiling state is obtained, the heated water is thrown away at certain timing during the process, the rice in the middle of start-up heating is washed by warm water and then, a predetermined amount of water or warm water is added again and the boiling state is obtained is exemplified. Moreover, a method in which, in the boiling maintaining process in which rice is continuously cooked while the boiling state is maintained, the rice in the middle of the process is taken out and washed by warm water or cold water and then, heated, and rice cooking is resumed is exemplified.

As described above, since the rice cooking method according to the present invention includes a process of washing away amylose eluted from the rice in the middle of rice cooking, an amylose amount adhering to the surface of the rice after rice cooking decreases, and aging of the rice is suppressed. As a result, dry feeling or discoloration caused by aging occurs less even after room-temperature storage or refrigerated storage, and rice with taste maintained is provided. Therefore, whether the rice to be cooked is rice with less amylose content such as low-amylose rice or not, cooked rice with less probability of aging to occur is provided. Moreover, by increasing the water adding amount, a change in a characteristic of the cooked rice is small even after refrigerated storage, and aging tends to be suppressed more effectively. That is, by decreasing the amylose amount adhering to the surface of rice after rice cooking by increasing the water adding amount, aging can be further suppressed.

The cooked rice cooked by the rice cooking method according to the present invention can be eaten as it is, but it can be mixed rice mixed with a condiment such as sushi vinegar, for example, and aging can be also suppressed. Therefore, the cooked rice obtained by the rice cooking method according to the present invention can be considered preferable as cooked rice for mixed rice mixed with sushi vinegar and other condiments.

The present invention will be explained below on the basis of the following examples in more detail but it is needless to say that the present invention is not limited to the following examples.

### Example 1

Rice was cooked by using a continuous rice cooking device illustrated in FIG. 1 and compared with cooked rice cooked by a rice cooker (IH-jar rice cooker: Panasonic SR-SU105) widely used in general households. The rice cooking device 1 illustrated in FIG. 1 includes a conveyer 2 for conveying rice, a steam chamber 3 for performing a steaming process by a high-temperature steam, and a water sprinkler 4 for pouring warm water to the rice moving on the conveyer 2 in the steam chamber 3 from above. Other than them, the rice cooking device 1 includes a steam supplying means for supplying a high-temperature steam and a warm water supplying means for supplying warm water but these means are not shown. The water sprinklers 4 are provided at four spots in a moving direction of the conveyer 2 in the steam chamber 3 and are arranged at each of sections obtained by defining a conveyer length in the steam chamber 2 into four sections (see water adding time slots 1 to 4 in FIG. 1). Moreover, in a width direction of the conveyer 2, a plurality of water sprinklers 4 are arranged as appropriate so that warm water is uniformly poured to the rice moving on the conveyer 2 in each of the sections. The conveyer 2 is accommodated in an accommodating chamber 5 to which a high-temperature steam is supplied, and the high-temperature steam supplied into the accommodating chamber 5 is supplied from below the conveyer 2 into the steam chamber 3.

[Rice Cooking Condition]

In a continuous rice cooking method (continuous rice cooking), rice heating time (moving time from an inlet of the steam chamber to an outlet of the steam chamber) was set to 22 minutes (time until all the inputted rice (prepared amount at 1 kg) is cooked from start of rice cooking is 26 minutes). Moreover, a water adding amount was set to 1.6 times of a usual amount (in this rice cooking time, the water adding amount in usual time is 130% of a rice amount=0.66 L/min. The same applies to the following.) so that the cooked rice with the same hardness substantially equal to that of the rice cooker is obtained by adjusting a temperature of the high-temperature steam and an added water temperature. In addition, adjustment was made so that warm water poured from above the rice flows down below the conveyer. Specifically, the amounts were set at 0.35 L/min, 0.25 L/min, 0.25 L/min, and 0.2 L/min (1.05 L/min in total) in order from the water sprinkler at an inlet of the steam chamber toward an outlet of the steam chamber. The added water temperature was approximately 90° C., the steam temperature was approximately 125° C., and a steam indoor temperature was 99 to 100° C.

After polished rice (“Koshihikari” made in Shiga Prefecture in 2010 (wash-free rice, polished to a yield of 90%)) as a sample was soaked in tap water in an amount of 1.5 times in a mass ratio for 1 hour, water was drained, and the rice was inputted into the rice cooking device. The cooked rice out of the outlet of the steam chamber was sampled into a sealed container (product name: “Tupperware”), kitchen paper was lightly placed on the cooked rice as a cover so that water drops do not fall onto the rice from the back of a lid and steamed at a room temperature for 30 minutes. Note that the sample polished rice had moisture at 14.6%, protein at 6.5%, and an amylose content at 18% (by near infrared spectroscopy, KettAN 800 by Kett Electric Laboratory).

As comparison, rice was cooked by using a rice cooker sold in the market. Polished rice soaked in tap water similarly to the above was automatically cooked with soaking water (in an ecology mode, rice cooking time for approximately 43 minutes). After rice cooking was completed, the rice was steamed at a room temperature for 30 minutes similarly to the case of continuous rice cooking.

[Measurement of Moisture Content]

A moisture content was measured by 105° C. normal-pressure drying method. The cooked rice was heated until 48 hours had elapsed since start of heating, and the moisture content was acquired from a value when a mass after drying became the minimum.

[Outflow Amount of Amylose]

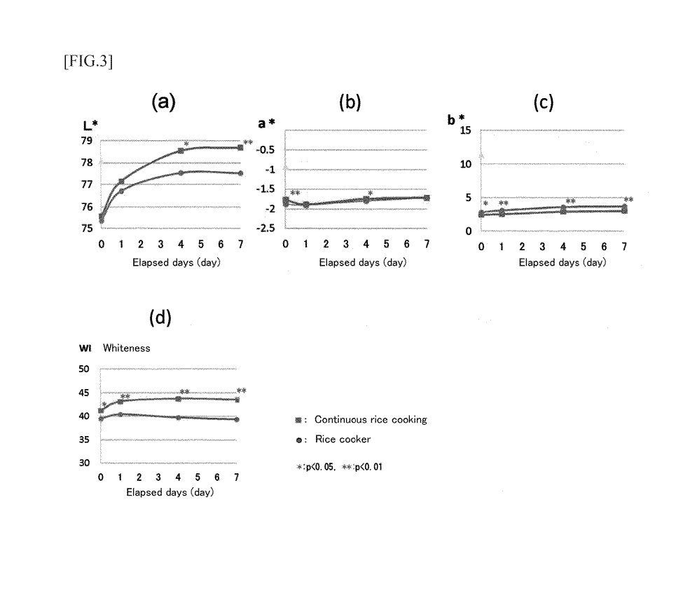

A liquid flowing out to below the conveyer (cooked rice washing liquid=waste liquid) was sampled for 15 seconds at every 1 minute after four minutes had elapsed since start of input, and the liquid was directly used for measurement of a reducing sugar amount and a total sugar amount. The reducing sugar amount was acquired by the Somogyi-Nelson method (Nelson N, A photometric adaptation of the Somogyi method for the determination of glucose, Journal of Biological Chemistry, 153 (2009), 375-380) and the total sugar amount by the phenol-sulfuric acid method (Dubois, M. et al., Colorimetric method for determination of sugars and related substances, Anal Chem., 28 (1956), 350-356). As a reference, the waste liquid generated when rice was newly cooked was sampled at 6 minutes, 10 minutes, 14 minutes, and 18 minutes after the rice cooking was started, and a solid amount was measured by freeze-drying the sampled waste liquids. The result is illustrated in FIG. 2. Note that pouring water was performed in time slots illustrated in FIG. 2. Three bars illustrated in each elapsed time in FIG. 2 indicate a waste-liquid sugar amount, a solid weight, and a reducing sugar amount from the left, respectively.

[Storage Test]

For the cooked rice obtained as above, a storage test was conducted for each of the following items (2) to (5). The cooked rice divided into small portions of 100 g each was wrapped by a wrap film for food and stored in a refrigerator at 5° C. (refrigerated storage) and at a room temperature of approximately 25° C. (room-temperature storage) and each portion was used as a test sample. Note that the cooked rice cooked by a rice cooker was sampled from a center part not in contact with the pot.

(1) Measurement of Surface Color

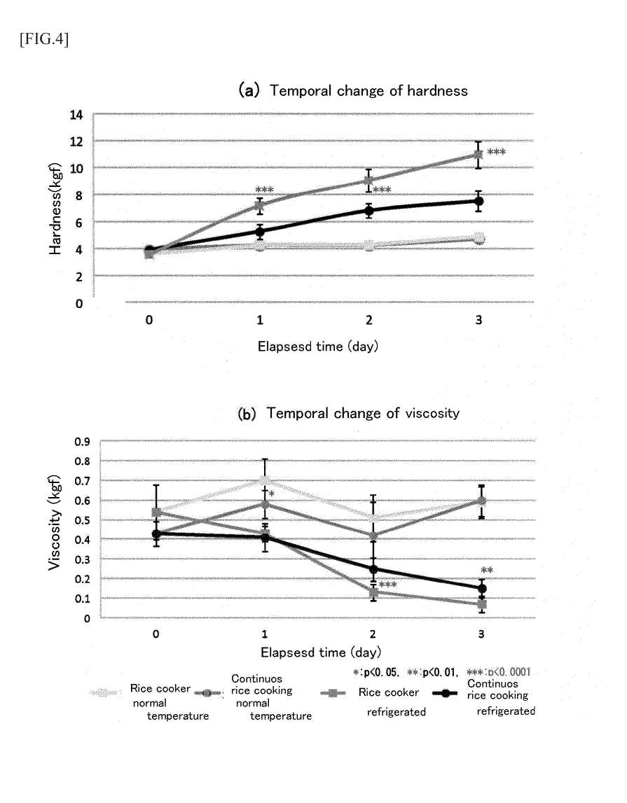

The divided cooked rice was spread so that there was as little gap as possible between rice grains and measurement was made by using a spectrophotometer (KONICAMINOLTA CM-700d) from above the wrap film. The measurement was made by using the SCE method and a measurement diameter of 8 mm, and the result was expressed by L* (brightness), a* (red−green direction), and b* (yellow−blue direction). Moreover, whiteness (by a calculation equation (WI=0.847Z−3Y) based on WI, ASTEM E 3113-73) was also compared. In the measurement, three samples were prepared for each condition, and an average value of measurement values in ten sessions was acquired. The result is illustrated in FIG. 3.

(2) Gelatinization Degree

Gelatinization degree was measured by a test method with partial modification of the BAP method (β-amylase-pullulanase method: Kainuma et. al, “New measurement method of gelatinization and aging of starch using β-amylase-pullulanase (BAP) system”, J. Jap. Soc. Starch Science, 28(4), 235-240). As enzymes, soybean β-amylase (by Nagase & Co., Ltd., crude enzyme sample 5 IU/mg) and pullulanase (by Hayashibara Biochemical Laboratories Inc., crude 2 IU/mg) were used. 170 mg of pullulanase and 17 mg of β-amylase were dissolved in 100 ml of 0.8M acetate buffer solution (pH 6.0) and then, centrifuged and supernatant was made an enzyme liquid.

Then, 8 ml of distilled water was added to 0.3 g of the sample cooked rice and distributed by a glass homogenizer (approximately 10 times), 2 ml of it was diluted by 0.8 M acetate buffer solution (pH 6.0) to 25 ml and made a sample. Besides that, 0.2 ml of 10N sodium hydroxide was added to the 2 ml of that and subjected to a warm bath at 50° C. for 5 minutes so as to be completely gelatinized. After that, 1 ml of 2N acetate was added so as to adjust pH to 6.0 and was further diluted by 0.8 M acetate buffer solution (pH 6.0) to 25 ml so as to obtain a fully gelatinized sample. Into 2 ml of the diluted solution, 2.5 ml of 0.8 M acetate buffer solution (pH 6.0) and 0.5 ml of the enzyme solution were added, respectively, and agitated and then, an enzyme reaction was performed in a constant temperature water bath at 37° C. for 30 minutes. A liquid obtained by adding an enzyme solution deactivated by heating instead of the enzyme solution and reacted was used as comparison. After the reaction, the enzyme was deactivated in boiling water. After that, the reducing sugar amount in the solution was acquired by the Somogyi-Nelson method (the same as above) and the total sugar amount by the phenol-sulfuric acid method (the same as above), and the degree of gelatinization was calculated by the following equation. The result is illustrated in Table 1.

Gelatinization degree (%)=decomposition rate of sample/decomposition rate of fully gelatinized sample×100

however Decomposition rate (%)=(generated reducing sugar amount−blank reducing sugar amount)/total sugar amount×100

(where sugar amounts are all maltose equivalent)

Moreover, the gelatinization degree was corrected by using a water content of the sample measured separately.

TABLE 1
Temporal change of gelatinization degree of cooked rice

| Refrigerated (days) | Continuous rice cooking (%) | Rice cooker (%) |
|---|---|---|
| 0 | 101.1 ± 2.5 | 99.7 ± 1.6 |
| 1 | 84.5 ± 0.5 | 79.7 ± 0.6 |
| 2 | 74.2 ± 2.1 | 63.0 ± 1.3 |
| 3 | 69.2 ± 2.9 | 61.9 ± 2.2 |
| 8 | 66.6 ± 3.1 | 43.6 ± 3.0 |

Average value ± standard deviation, n = 3

(3) Physical Properties

Viscoelasticity was measured as a physical property. The measurement was made by using a hardness and glutinosity meter (SATAKE, RHS1A, load cell A&D Co., Ltd. LC-205-K020). Conforming to an operation procedure of the device, 8 g of the sample cooked rice was sampled on a dedicated metal petri dish and the cooked rice was solidified by pressing with 18.5 kgf for 10 seconds on a front surface and a back surface, respectively. The solidified cooked rice was placed on a sample base and measured by moving a plunger column (with a diameter of 24 mm) at a speed of 13.3 mm/sec in two times of a creeping operation. The measurement was made 7 times each. The result is illustrated in FIG. 4.

(4) Sensory Test

In order to compare a difference in tastes caused by a difference in the rice cooking methods, a sensory test was conducted for the cooked rice on the day when the rice was cooked and the cooked rice in refrigerated storage at 5° C. for 1 day.

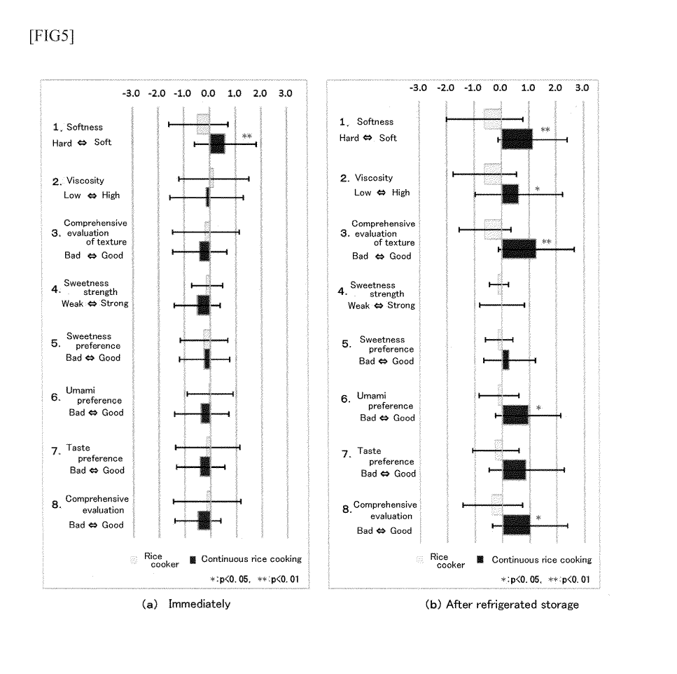

The cooked rice cooled to approximately 25° C. after being steamed was used as a sample of the day of cooking. The one in refrigerated storage was taken out 2 hours before the sensory test, returned to a normal temperature and made a sample after refrigerated storage. The sample cooked rice was eaten by 16 to 20 public monitors and evaluated for appearance, aroma (identification and preference by a pair test), food texture, taste and comprehensive evaluation (identification and preference by a rating system). Comparative tests were conducted by an assay using a pair test for the appearance and aroma and by Mann-Whitney's U test for the food texture, taste and comprehensive evaluation. The result is illustrated in Table 2 and FIG. 5.

TABLE 2

| | | Immediately after | | | After refrigerated | | |
|---|---|---|---|---|---|---|---|
| | | cooking | | | storage | | |
| | | Rice | | Cannot | Rice | | Cannot |
| | | cooker | Line | say | cooker | Line | say |
| Appear- | Whiteness | 3 | 15 | 2 | 2 | 13 | 1 |
| ance | Luster | 7 | 9 | 4 | 4 | 11 | 1 |
| | Preference | 6 | 11 | 3 | 4 | 11 | 1 |
| | (looks | | | | | | |
| | tasty) | | | | | | |
| Aroma | Strong | 15 | 2 | 2 | 10 | 5 | 1 |
| (before | aroma | | | | | | |
| eating) | Preference | 9 | 6 | 4 | 7 | 6 | 3 |
| | (looks | | | | | | |
| | tasty) | | | | | | |

* p < 0.05 Pair test (rice cooker vs. line rice), the numerals in Table indicate the number of people.

[Evaluation]

(Moisture Content)

The moisture content of the cooked rice used as the samples was approximately 63% for the continuous rice cooking and approximately 62% for the rice cooker, and the moisture content of the continuous rice cooking had a tendency slightly higher than that of the rice cooker but the rice was cooked in substantially the same cooked state.

(Outflow Amount of Amylose)

Subsequently, the waste liquid flowing out to below the conveyer was sampled, and sugar content in the waste liquid was measured and the result as illustrated in FIG. 2 was obtained. As can be understood from FIG. 2, the waste liquid generated during rice cooking contained sugar in all the time slots. The reducing sugar amount in the waste liquid was at a detection limit or less and the sugar in the waste liquid was polysaccharides (non-reducing sugar). Moreover, though not shown in the figure, in a color reaction in which an iodine reagent was added to the waste liquid, characteristic blue was presented in the coloration of amylose, and purplish red exhibited when amylose and amylopectin are present was not presented. Moreover, since the solid amount and the amount of all the sugar (non-reducing sugar) in the waste liquid substantially matched, it can be said that most of the solid amount in the waste liquid is starch (amylose). From these facts, it can be concluded that most of the non-reducing sugar in the waste liquid is amylose and the amylose eluted during the rice cooking was washed away during pouring water under the rice cooking condition in the example 1. This point was also confirmed from molecular weight distribution by gel filtration analysis indicated by solid substances in the waste liquid (the result is not shown). Moreover, from FIG. 2, the eluted amount of amylose rapidly rose at six minutes after the start of rice cooking and reached a peak of eluting at eight minutes after the start, and it is estimated that the eluted amount of amylose in this time slot is larger than those in the other time slots. Note that, though the amount of eluted amylose at four to five minutes after the start is small, this is considered to be caused by a large warm water amount absorbed by rice in this time slot. On the other hand, since rice cooking by the rice cooker is performed in a closed system, amylose eluted in a rice cooking process is considered to become the oneba and remains on the cooked rice.

Subsequently, when the cooked rice by continuous rice cooking and the cooked rice by the rice cooker were compared, the following results were obtained:

(1) Surface Color

Regarding the brightness (L*) of the cooked rice, a significant difference was not shown on the day of rice cooking and the following day, but the cooked rice by the continuous rice cooking was slightly higher, and the cooked rice by the continuous rice cooking was significantly higher four days later and seven days later. Moreover, an a value indicating redness−green was slightly larger in the cooked rice by the continuous rice cooking, but a b value indicating yellowness was significantly smaller in the cooked rice by the continuous rice cooking. The whiteness (WI) calculated from the brightness, the a value and the b value was significantly higher in the cooked rice by the continuous rice cooking. Moreover, when the cooked rice on the day of rice cooking was examined visually, the cooked rice by the continuous rice cooking was slightly whiter as will be described later, and the cooked rice by the rice cooker was somewhat yellowish (images illustrating the comparison are not shown). From these facts, visually recognized aging (change in whiteness) can be said to be smaller in the continuous rice cooking in which amylose was washed away.

(2) Degree of Gelatinization

Regarding the degree of gelatinization, the degree of gelatinization which was substantially 100% on the day of rice cooking both for the continuous rice cooking and for the rice cooker fell to 84.5% for the continuous rice cooking and 79.7% for the rice cooker on the day following the rice cooking (one day later) when stored in refrigeration, and a difference was found between the both. Moreover, the difference between the both became larger as the number of days of storage increased, and it was made clear that lowering of the degree of gelatinization was suppressed in the continuous rice cooking.

(3) Physical Properties (Elasto-Viscosity)

The hardness on the day of rice cooking was substantially the same value both for the continuous rice cooking and for the rice cooker, and it was confirmed that the rice was cooked to substantially the same hardness. When stored at a normal temperature, a large change was not found in hardness both in the cooked rice by the continuous rice cooking and the cooked rice by the rice cooker. On the other hand, in the case of refrigerated storage, hardness rapidly rose to 5.3 kgf one day later, 6.8 kgf two days later, and 7.5 kgf three days later for the cooked rice of the rice cooker, and the same rise in hardness was found in the cooked rice by the continuous rice cooking, but the rise was gentler than that by the rice cooker.

Viscosity was larger in the cooked rice by the rice cooker than the cooked rice by the continuous rice cooking on the day of rice cooking. In the refrigerated storage, rapid lowering in viscosity was found in the cooked rice by the rice cooker. Thus, the value became substantially the same on the day following rice cooking, and the cooked rice by the continuous rice cooking had viscosity larger than that of the cooked rice by the rice cooker two days later. On the other hand, in storage at a normal temperature, viscosity rose both for the continuous rice cooking and for the rice cooker on the day following the rice cooking, but the values became the same three days later.

From the temporal changes in hardness and viscosity, it was made clear that the rise in hardness and the decrease in viscosity involved in aging by refrigerated storage were gentler in the cooked rice by the continuous rice cooking than by the rice cooker. Moreover, the fact that the viscosity of the cooked rice by the rice cooker is larger than that of the cooked rice by the continuous rice cooking on the day of rice cooking corresponds to adhesion of so-called oneba to the cooked rice by the rice cooker.

(4) Sensory Test

Regarding the “whiteness”, such evaluation was made that the cooked rice by the continuous rice cooking was significantly (p<0.05) whiter than the cooked rice by the rice cooker both on the day of rice cooking and after the refrigerated storage. There was no significant difference in “luster” but more people replied that the cooked rice by the continuous rice cooking had luster in the cooked rice after the refrigerated storage. There was no significant difference in the “appearance”, either, but many people evaluated that the cooked rice by the continuous rice cooking looked tasty.

Regarding the “aroma”, it was evaluated that the cooked rice by the rice cooker had a significantly (p<0.05) stronger aroma on the day of rice cooking and the same applied to the rice on the following day. However, the result was fifty-fifty on the “preference of aroma”, and the strong aroma was not necessarily preferred, and no relation to aging was found.

Regarding the “food texture”, it was evaluated that the cooked rice by the continuous rice cooking was significantly (p<0.01) softer both on the day of rice cooking and after the refrigerated storage. Moreover, the cooked rice by the continuous rice cooking after storage had significantly (p<0.05) high viscosity and was significantly (p<0.01) preferred in the comprehensive evaluation of the food texture, and it can be considered that aging is suppressed in the cooked rice by the continuous rice cooking and favorable food texture is maintained. Furthermore, the cooked rice by the continuous rice cooking after refrigerated storage was significantly (p<0.05) preferred in the comprehensive evaluation in which appearance, food texture and flavor were combined.

As described above, it was confirmed that aging was suppressed in the continuous rice cooking in which amylose eluted during rice cooking is washed away as compared with the rice cooking by the rice cooker without washing away amylose and luster and softness were maintained relatively favorably even in the case of refrigerated storage.

### Example 2

The cooked rice was cooked by increasing the water adding amount in the continuous rice cooing method. The rice cooking conditions excluding the water adding amount was set the same as those in Example 1, and three stages of the water adding amounts, that is, an experiment example 1 in which the water adding amount was set substantially similar to Example 1, an experiment example 2 with the water adding amount slightly larger than that, and an experiment example 3 with the water adding amount much larger than that. Specifically, the water adding amounts were set at 0.35 L/min, 0.26 L/min, 0.25 L/min, and 0.2 L/min (total water pouring amount=1.05 L/min, approximately 1.6 times of the usual case) in the experiment example 1, at 0.43 L/min, 0.35 L/min, 0.35 L/min, and 0.25 L/min (total water pouring amount=1.38 L/min, approximately 2.1 times of the usual case) in the experiment example 2, and at 0.50 L/min, 0.45 L/min, 0.45 L/min, and 0.30 L/min (total water pouring amount=1.70 L/min, approximately 2.7 times of the usual case) in the experiment example 3 in order from the water sprinkler at an inlet of the steam chamber toward an outlet of the steam chamber, respectively.

As comparison, rice was cooked by using a rice cooker sold in the market similarly to Experiment 1. For a water adding rate, the water adding amount was adjusted so that a moisture content and an increase rate by cooking became substantially equal to those in the continuous rice cooking, and two types of water adding amounts were set, that is, a comparative example 1 (water adding ratio 1.4) in which the water adding amount was set larger than that in the usual rice cooking and a comparative example 2 (water adding ratio 1.65) in which the water adding amount was set much larger than that.

Moreover, blended vinegar (rice vinegar in which sugar and salt are dissolved) in a mass ratio of 10% was mixed in the cooked rice (polished rice) obtained in the experiment example 1 and the experiment example 2 so as to obtain sushi rice. The storage test was conducted for the obtained cooked rice and sushi rice.

(Moisture Content)

The moisture content of the cooked rice (polished rice) was measured similarly to Experiment 1.

(Outflow Amount of Amylose)

The waste liquid flowing out to below the conveyer was sampled similarly to Experiment 1, and sugar content in the waste liquid was measured. The measurement was made for the cooked rice (polished rice) in the experiment example 1 and the experiment example 2.

(Storage Test)

Changes on the physical properties (viscoelasticity: hardness and viscosity) were examined for the cooked rice (experiment examples 1 to 3, comparative examples 1 to 2) and sushi rice (experiment examples 1 to 3, comparative examples 1 and 2) obtained as above. The cooked rice divided into small portions of 100 g each was wrapped by a wrap film for food and stored in a refrigerator at 5° C. (refrigerated storage) and each portion was used as a test sample. The measurement of the physical properties was made similarly to Experiment 1.

[Evaluation]

(Moisture Content)

The moisture content of the cooked rice used as the samples was approximately 63.7% in the experiment example 1, 65.2% in the experiment example 2, 65.5% in the experiment example 3, 60.9% in the comparative example 1, and 63.1% in the comparative example 2. The increase rate by cooking was 2.3 times in the example 1, 2.4 times in the example 2, 2.5 times in the example 3, 2.3 times in the comparative example 1, and 2.4 times in the comparative example 2, and the cooked rice by the continuous rice cooking had the cooked state substantially similar to the cooked rice by the rice cooker.

(Outflow Amount of Amylose)

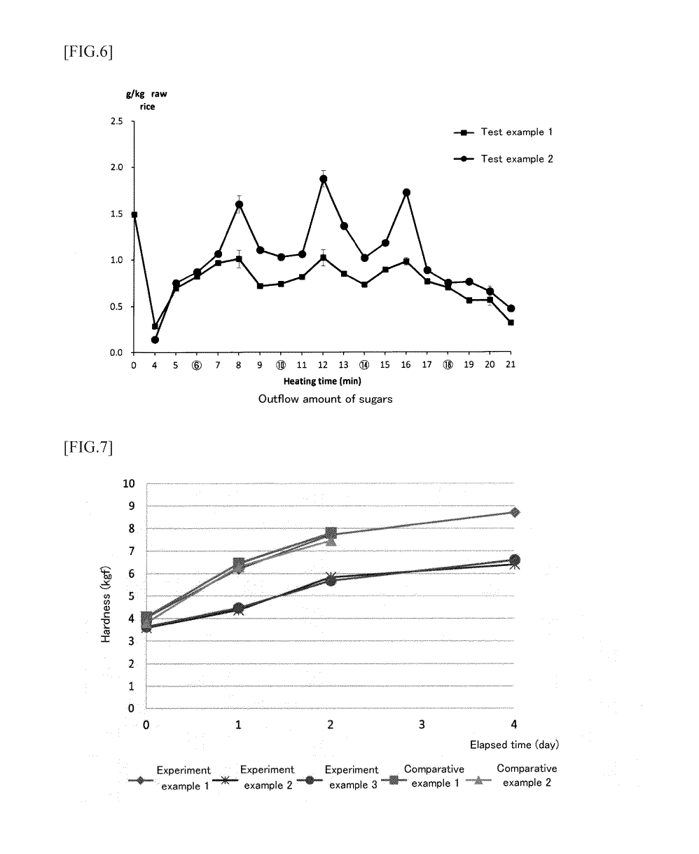

The outflow amount of amylose is illustrated in FIG. 6. As illustrated in FIG. 6, if the water adding amount was increased, the outflow amount of sugars became large. Since most of the sugars is amylose, it was shown that more amylose was washed away by increasing the water adding amount.

(Physical Properties: Elasto-Viscosity)

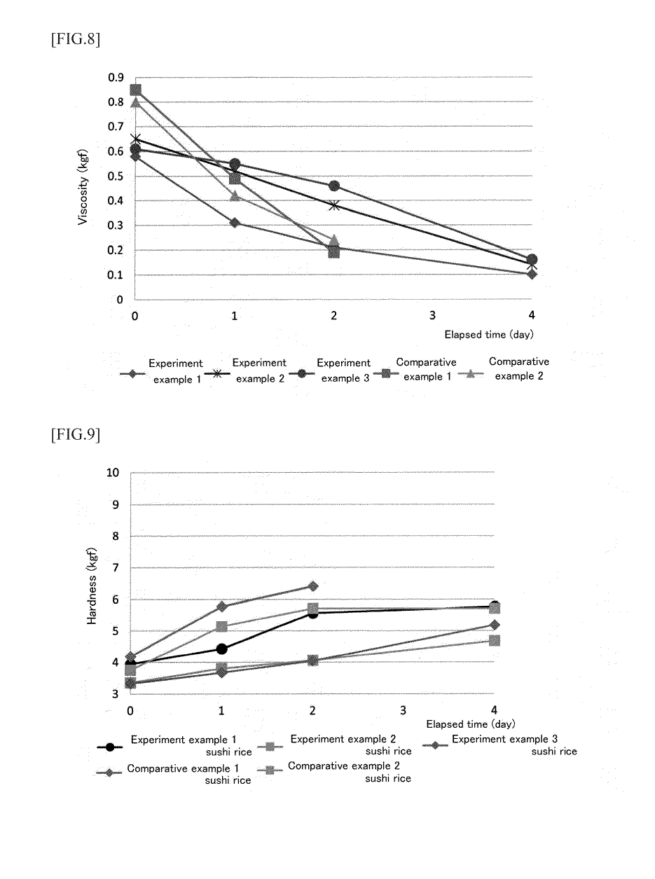

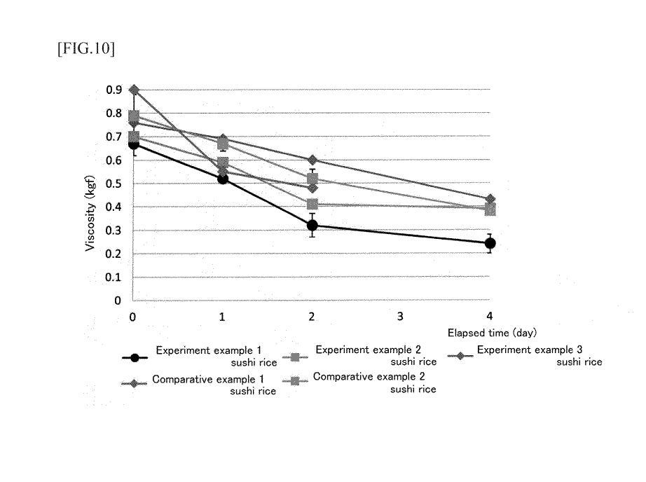

The temporal change in hardness of polished rice is illustrated in FIG. 7, the temporal change in viscosity of the polished rice in FIG. 8, the temporal change in hardness of sushi rice in FIG. 9, and the temporal change in viscosity of sushi rice in FIG. 10. When the polished rice is subjected to refrigerated storage, a rise in hardness was suppressed as the water adding amount was increased for the cooked rice cooked by the continuous rice cooking.

Regarding viscosity, the cooked rice (polished rice) cooked by the rice cooker rapidly lost viscosity by refrigerated storage similarly to the example 1 even if the water adding amount was increased. The initial rapid decrease was suppressed in the cooked rice (polished rice) cooked by the continuous rice cooking as compared with the cooked rice by the rice cooker, and the decrease in viscosity was further suppressed by increasing the water adding amount.

It was shown that, when the sushi rice was subjected to refrigerated storage, hardness tended to be substantially similar to that in the polished rice in the refrigerated storage, the rise in hardness of the cooked rice cooked by the continuous rice cooking was suppressed by increasing the water adding amount and that aging was difficult to progress.

Regarding viscosity, too, a raid decrease in the viscosity was found in the case of rice cooker in some cases but such rapid change in viscosity was suppressed in the cooked rice cooked by the continuous rice cooking. Moreover, similarly to the case of polished rice, a change in viscosity was suppressed by continuous rice cooking.

From the above facts, it was confirmed that an aging phenomenon was further suppressed by increasing the water adding amount and by sufficiently washing away amylose coming out to the surface of rice grains during rice cooking. Moreover, in the case of sushi rice, it was confirmed that suppression of the aging phenomenon by increasing the water adding amount during rice cooking was further remarkable. As described above, it can be said that the cooked rice obtained by the rice cooking method according to the present invention is preferable not only to be eaten as it is as polished rice but also as the cooked rice for mixed rice such as sushi rice.

1. (canceled)

2. A rice cooking method including a steaming process by a high-temperature steam and being a continuous rice cooking method in which warm water is added in the steaming process,
characterized by including, in the steaming process, a process of pouring warm water in an amount larger than a water adding amount required for rice cooking and of washing away amylose eluted from the rice in the steaming process.

3. The rice cooking method claimed in claim 2, characterized in that warm water is poured at an initial stage of the steaming process in an amount larger than that at the subsequent stage of the steaming process.
